(19) United States
(12) Patent Application Publication
(10) Pub. No.: US 2003/0039743 A1
(43) Pub. Date: Feb. 27, 2003

(54) Method for depositing an adhesion-promoting layer on a metallic layer of a chip

(76) Inventors: Lothar Henneken, Ludwigsburg (DE); Silvan Hippchen, Sersheim (DE)

Correspondence Address: KENYON & KENYON, ONE BROADWAY, NEW YORK, NY, 10004, US

(21) Appl. No.: 10/217,064

(22) Filed: Aug. 12, 2002

(30) Foreign Application Priority Data
Aug. 10, 2001 (DE) 101 39 555.8

(51) Int. Cl. B05D 3/10; B05D 1/18; B05D 1/36; B05D 5/12

(52) U.S. Cl. 427/8; 427/430.1; 427/438; 427/305; 427/404; 427/98

(57) ABSTRACT

A method for depositing an adhesion-promoting layer on a spatially bounded metallic layer of a silicon chip is provided. The adhesion-promoting layer is deposited, using at least one wet-chemical process. During the wet-chemical process, the concentration of an inhibitor of a multi-component process bath is checked in at least approximately continuous manner and adjusted to a constant value. The adjustment of the inhibitor concentration is independent of the adjustment of the concentrations of other process-bath components.

### FIELD OF THE INVENTION

The present invention relates to a method for depositing an adhesion-promoting layer on a spatially bounded metallic layer of a chip.

### BACKGROUND INFORMATION

The so-called flip-chip technique, by which silicon chips are mounted on a substrate such as a printed circuit board, is known to be in practical use. In this technique, the “naked” chip is mounted face-down on the substrate. One of the two joining partners is provided with metallic humps or so-called soldering bumps. The other joining partner is provided with so-called landing surfaces for the soldering bumps, which take the form of solderable pads.

In addition, it is also standard practice to position pads, which each have solderable metal humps or soldering bumps, on both the silicon chips and the substrates. The active side of chips prepared in this manner can then be positioned on the substrate having the proper pads, and the chips can be simultaneously contacted in a so-called reflow process.

The advantages of the flip-chip technique are that, in comparison with wire-bonding or TAB technology, a larger number of connections may be produced, while the space requirement is low. In addition, the flip-chip technique has the advantage that a simultaneous bonding method can be implemented, and small parasitic effects, such as connection resistances, connection capacitances, and connection inductances, can be prevented.

An important condition for reliably bonding the silicon chip to the substrate is the deposition of a reliable adhesion-promoting layer between the aluminum or copper pads of the chip and the applied soldering bumps. This intermediate layer is referred to as under-bump metallization (UBM). In order to reduce the production costs, the adhesion-promoting layer may be deposited on the pads by wet-chemical processes instead of sputtering technology processes. A chemically reducing nickel bath, by which nickel layers having a thickness of approximately 5 μm are deposited on the pads, is normally used for this purpose. A gold layer, which has a thickness of approximately 0.05 μm and is also chemically precipitated on the nickel layer by wet processes, is deposited on the nickel layer in order to protect against corrosion.

To ensure proper functioning, the deposited nickel layer must have a surface that is as flat and uniform as possible and does not have defects, for this ensures that the soldering bumps reliably adhere to the pads. Because of the small dimensions of the microstructures on which the nickel layers and gold layers are precipitated, imperfections due to mass-transport phenomena and local instances of overstabilization caused by process-bath additives often occur in wet-chemical processes. The reason for this is small pad diameters of approximately 100 μm that are less than the thickness of the hydrodynamic boundary layer, which results in the mass transport of inhibitors to the pad surface being impaired.

In addition, a low liter loading of the process baths, which can lead to the pads being highly loaded with inhibitors, effects the plating quality of the pads during the UBM process. In this context, the liter loading is defined as the ratio of the surface to be plated to the volume of the process solution or the process bath. During the plating of the microstructures, unfavorable hydrodynamics and the accompanying local accumulation of a process-bath inhibitor in the edge region of the microstructures cause unwanted imperfections. Such imperfections may range from a distinct edge weakness to a completely missing nickel layer on the pad.

However, a reduction in the inhibitor concentration of the bulk phase, i.e. of the process bath as a whole, which could prevent the accumulation of the inhibitor, causes the nickel bath to be chemically unstable. The plating process then tends toward a distinct formation of buds on the pads, or even toward a spontaneous decomposition in the plating equipment.

Commercial, chemical nickel baths generally contain thiourea and lead(II) ions as an accelerator and inhibitor, respectively. These baths are adjusted for the plating of component parts having a large surface area, in such a manner, that the concentrations of the two additives decrease in the same proportions during the operation. Subsequent dosing again increases their concentrations in the same proportions and ensures a uniform plating quality for these conditions.

In the case of chips or wafers, whose ratio of the pad surface area to the entire surface area is unfavorable, the low liter loading causes the concentration ratios to shift during the plating process in such a manner that the unwanted accumulation of lead components results. This undesirably high concentration of the lead components leads to edge weakness or a missing nickel layer on the microstructures, which is additionally supported by unfavorable mass transport conditions.

### SUMMARY

The method of the present invention for depositing an adhesion-promoting layer on a spatially bounded metallic layer of a chip has the advantage that metallic layers on wafers may be reliably plated with a uniform nickel layer and a superposed gold layer, using wet-chemical processes, and an edge weakness or a completely missing nickel layer on the metallic layers, as well as the distinct formation of buds on the metallic layers, are prevented.

The concentration of a process-bath inhibitor may be checked during the wet chemical process, in an approximately continuous or quasi-continuous manner, and adjusting it to a constant value, which allows stable operating conditions for the plating of metallic layers on wafers and prevents the above-described imperfections from occurring.

The adjustment of the inhibitor concentration may be decoupled from the adjustment of the concentrations of the other process-bath components, so that the inhibitor concentration is adjusted in a simple and rapid manner.

The quasi-continuous control of a critical process-bath component, i.e. of the inhibitor, allows the concentration of this inhibitor to be kept at a constant, low level, so that even when the liter loading of a process bath is low, it is possible to obtain uniform layers on microstructures, without imperfections.

### BRIEF DESCRIPTION OF THE DRAWINGS

FIG. 1 illustrates a method sequence of an under-bump metallization process.

FIG. 2 illustrates a concentration curve of process-bath components in a chemical nickel process of an under-bump metallization process.

### DETAILED DESCRIPTION

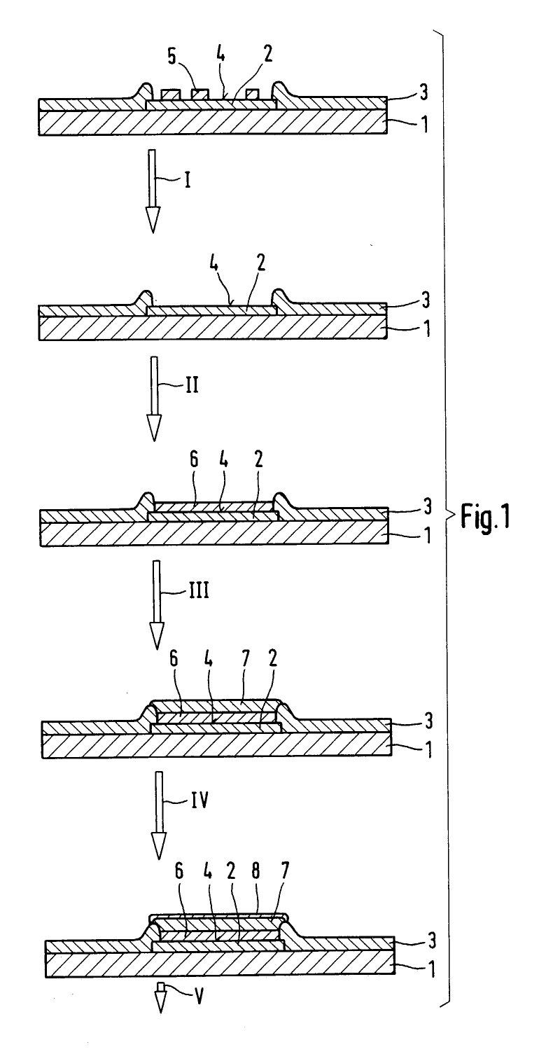

The under-bump metallization of a silicon or silicon oxide chip by flip-chip technology is represented in steps in FIG. 1. Chip or wafer 1 is provided with a metallic layer or an aluminum pad 2 and a passivation layer 3 with oxides 5 being formed on a surface 4 of aluminum pad 2. The surface is scrubbed free of lightly adhering oxides prior to aluminum pad 2 being plated with a nickel layer. In addition, organic impurities are removed, and the wettability of aluminum pad 2 is increased by a treatment method. This part of the process is illustrated in FIG. 1 by arrow I, and yields, as an intermediate product, a wafer having an aluminum pad 2 whose surface 4 is free of oxides 5 and organic impurities.

In a pre-treatment step, aluminum pad 2 is subsequently treated with a pickle, and a catalyst layer 6 having a thickness of approximately 50 nm is produced on surface 4 of aluminum pad 2. This produces a uniform layer and increases the layer adhesion of aluminum pad 2. This treatment step prior to the actual plating process is illustrated in FIG. 1 by arrow II.

A nickel layer 7 is then deposited on catalyst layer 6, using a wet-chemical plating process. This method step is shown in detail by arrow III.

A gold layer 8 is then deposited on nickel layer 7, in order to provide corrosion protection to nickel layer 7 and improve the solderability. This process stage is represented in FIG. 1 by arrow IV. Wafer 1, which is prepared for a reflow process in this manner and has an adhesion-promoting layer, i.e. nickel layer 7 in connection with gold layer 8, may then be subjected to additional, subsequent processes, which are symbolically represented in FIG. 1 by arrow V.

In order to plate wafer 1 or aluminum pad 2, the configuration described here uses commercial, chemical nickel baths, wherein the process-bath components generally include thiourea and lead (II) ions as an accelerator and inhibitor, respectively. Such baths are normally used for the plating of component parts having a large surface area and, in this connection, are adjusted in such a manner that the concentrations of the two process-bath components decrease in the same proportions during the plating process. When they are subsequently dosed, they are added to the process bath in the same proportions, i.e. the conditions for a uniform plating quality are fulfilled.

In the case of wafers where the ratio of the pad surface area to the entire surface area of the wafer is unfavorable, the concentration ratios in the region of the pads to be plated shift during the plating process due to the low liter loading of the process bath. In this case the inhibitor, i.e. the lead component, accumulates, so that the above-described, subsequent dosing does not yield the necessary concentrations of the process components.

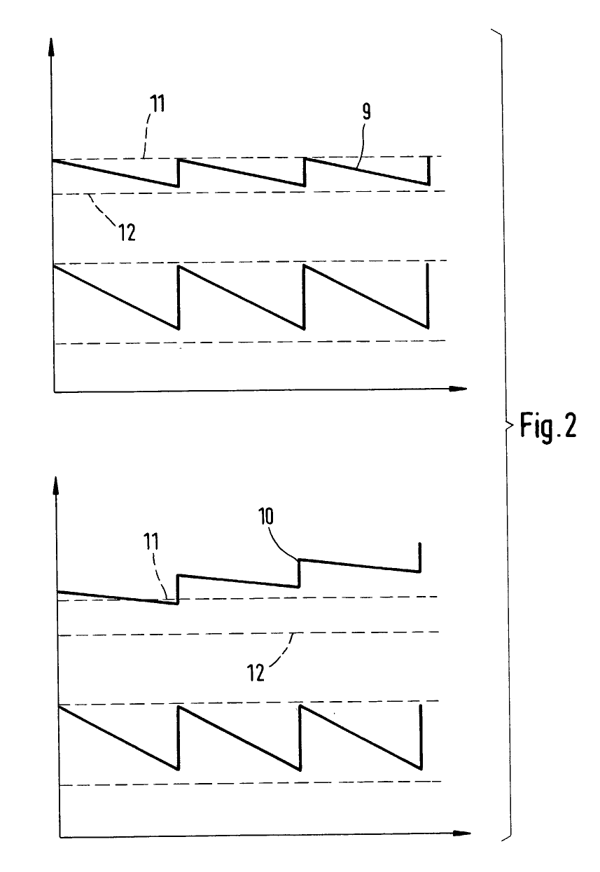

The top left representation in FIG. 2 illustrates a concentration curve 9 of the lead(II) ions in the process bath in the case of normal liter loading, and the top right representation of FIG. 2 illustrates sawtooth-like concentration curve 10 of lead(II) ions in the process bath in the case of a low liter loading. The saw-tooth profile results from the discontinuous rectification of the concentration between two wafer batches, the two dotted lines 11, 12 representing a concentration range, inside which the plating process yields the smooth layer surfaces that are desired.

When the liter loading is low, the lead concentration in the process bath increases with each subsequent dosing, so that the actual lead concentration moves out of the concentration range, which leads to unsatisfactory plating results. In order to solve this problem, the present invention provides for special subsequent-dosing solutions being used, and these being added to the process bath in a certain order.

An analysis of the composition of the process bath is repeated before plating each wafer batch, the nickel concentration of the process bath first being complexometrically or photometrically analyzed, and then adjusted, using a first regenerating solution that contains nickel(II) ions and organic accelerators. The nickel concentration is may be adjusted to a value of approximately 5.0±0.3 g per liter of process bath.

The concentration of lead(II) ions is then determined polarographically. In order to adjust the concentration, the process bath, which may have a bath volume of approximately 50 liters, is adjusted by a second regenerating solution that includes hypophosphite, complexing agents, and lead(II) ions. In this case, the concentration of lead(II) ions is adjusted to 1.0±0.1 mg per liter of process bath.

The hypophosphite concentration is determined during a third analysis, in which case iodometric titration may be used as an analysis method. When the value of the hypophosphite concentration of the process bath deviates from a desired value, it is adjusted by adding a third regenerating solution, which has a composition that essentially corresponds to the composition of the second regenerating solution. However, the third regenerating solution does not contain any lead(II) ions.

This quasi-continuous analysis procedure allows the subsequent dosing of lead(II) ions to the process bath to be decoupled from the subsequent dosing of the remaining bath components, i.e. the constant process-bath conditions are maintained and, in particular, the lead concentration may be adjusted to 1.0±0.1 mg per liter of process bath without any further, expensive concentration analyses.

The analysis of the individual process-bath components is repeated prior to plating each wafer batch, although it lies within the discretion of the expert to continuously check the analysis of the process-bath composition during the actual plating process, i.e. during the wet-chemical process, and, in particular, to continuously adjust the inhibitor concentration of the process bath, i.e. the concentration of lead(II) ions, to a constant value. This procedure allows a uniform lead-concentration curve of the process bath to be set inside the concentration range.

This prevents individual process-bath components from becoming overly concentrated to a critical extent, which is represented in FIG. 2 and occurs when subsequent dosing is only performed sporadically, without decoupling the subsequent dosing of the bath components from each other.

The decoupling of the addition of the individual process-bath components is accomplished in a simple manner, in that a regenerating solution equivalent to the second regenerating solution is added to the process bath having lead(II) ions, and the third “unleaded” regenerating solution, which is equivalent to the second regenerating solution minus the lead(II) ions, is subsequently added. This third, “unleaded” regenerating solution allows the concentration of the reducing agent, i.e. of the hypophosphite, to be set. Thus, the subsequent dosing of the inhibitor concentration, i.e. of the lead concentration, and the hypophosphite concentration is no longer tied to the proportional addition of the second and third regenerating solutions.

Because the amounts added are small in comparison to the volume of the entire process bath, the above-described, sequential, quantitative regulation of the different regenerating solutions does not have a noticeable effect on the concentrations of the critical process-bath components with respect to the entire volume, i.e. amount, of the process bath, wherein the separate, subsequent dosing described above may be performed without difficulty.

The above-described procedure and implementation of the method allows microstructures on wafers to be uniformly plated by wet-chemical processes, using commercial process baths that are configured for a normal liter loading and therefore have a sufficient service life due to stabilization.

What is claimed is:

1. A method for depositing an adhesion-promoting layer on a spatially bounded metallic layer of a chip, comprising:
depositing the adhesion-promoting layer by at least one wet-chemical process using a multi-component process bath;
analyzing a concentration of an inhibitor of the multi-component process bath during the wet-chemical process in at least approximately continuous manner; and
adjusting the concentration of the inhibitor to a constant value, the adjusting of the inhibitor concentration being independent of adjusting of concentrations of other process-bath components.

2. The method according to claim 1, wherein the process bath has components that accelerate the depositing of the adhesion-promoting layer.

3. The method according to claim 1, wherein the process bath has at least nickel, lead, and hypophosphite.

4. The method according to claim 3, wherein a nickel concentration of the process bath is analyzed one of complexometrically and photometrically.

5. The method according to claim 3, further comprising:
adding a regenerating solution containing nickel(II) ions and organic accelerators to the process bath to adjust a nickel concentration.

6. The method according to claim 3, wherein a lead concentration of the process bath is determined polarographically.

7. The method according to claim 3, further comprising:
adding to the process bath a regenerating solution containing hypophosphite, complexing agents, and lead(II) ions to adjust a lead concentration.

8. The method according to claim 3, wherein a hypophosphite concentration is determined by iodometric titration.

9. The method according to claim 3, further comprising:
adding a regenerating solution to the process bath to adjust a hypophosphite concentration, the regenerating solution containing hypophosphite and complexing agents.

10. The method according to claim 3, further comprising:
adding a first regenerating solution containing nickel (II) ions and organic accelerators to the process bath;
subsequently adding a second regenerating solution containing hypophosphite, complexing agents and lead (II) ions to the process bath; and
subsequently adding a third regenerating solution containing hypophosphite and complexing agents to the process bath;
wherein the sequence of first, second and third regenerating solutions are added to decouple a quantitative regulation of the process-bath lead concentration from a quantitative regulation of remaining process-bath components.

11. The method according to claim 1, wherein the metallic layer is one of an aluminum and a copper layer.

12. The method according to claim 1, further comprising:
providing a passivation layer to the surface of the chip, except in a region where the metallic layer is provided.

13. The method according to claim 1, further comprising, prior to the depositing of the adhesion-promoting layer:
cleaning the metallic layer; and
activating the metallic layer to increase wettability.

14. The method according to claim 1, further comprising, prior to the depositing of the adhesion-promoting layer:
pre-treating the metallic layer with a zincate pickle to provide a catalyst layer which is situated between the metallic layer and the adhesion-promoting layer.

15. The method according to claim 1, wherein the adhesion-promoting layer is made of a nickel layer and a superjacent gold layer, the nickel layer being an adhesion and contact layer, and a superjacent gold layer protecting against corrosion and improving the soldering capability.

16. The method according to claim 1, further comprising:
positioning the chip having the adhesion-promoting layer on a substrate and simultaneously bonding the substrate to the chip in a reflow process.
